(19) United States
(12) Patent Application Publication
(10) Pub. No.: US 2026/0332436 A1
(43) Pub. Date: Oct. 22, 2026

(54) METHOD AND APPARATUS FOR MITIGATING A RISK OF SERVICE UNAVAILABILITY DURING CA MIGARATION

(71) Applicant: Nokia Technologies Oy, Espoo (FI)

(72) Inventors: German PEINADO GOMEZ, Wroclaw (PL); Rakshesh PRAVINCHANDRA BHATT, Bangalore (IN); Jing PING, Chengdu (CN)

(21) Appl. No.: 19/112,256

(22) PCT Filed: Sep. 16, 2022
(86) PCT No.: PCT/CN2022/119396

§ 371 Date: Mar. 16, 2025

(51) Int. Cl. H04L 9/32; H04L 9/40

(52) U.S. Cl. CPC H04L 9/3268; H04L 9/3247; H04L 9/40

(57) ABSTRACT

Methods and apparatus are disclosed for mitigating a risk of service un-availability during a migration of certification authority (CA) for the communication network. A method comprises, causing a creating of a first set of network function instances which is redundant for a second set of network function instances using a new root certificate updated in a migration of certificate authority (CA), wherein respective certificates for the second set of network function instances are to be updated in the migration of CA; and causing services being served by the second set of network function instances to be transferred to the first set of network function instances.

### TECHNICAL FIELD

Embodiments of the disclosure generally relate to security and availability of a communication network, and more particularly, to methods and apparatus for mitigating a risk of service un-availability during a migration of certification authority (CA) for the communication network.

### BACKGROUND

In order to ensure secure communications between various network functions of a communication network, protocols for security, such as TLS, IPSEC, SSH etc., are used. The secure connection establishment for many of these protocols needs digital certificate exchange between network entities involved in the communication.

Digital certificates are used world-wide to establish trust, and optionally for authentication, between various network entities. Certification authorities provide these certificates with certain expiry dates. Also, various encryption and hashing algorithms are used for secure connection establishment. The digital certificates include information regarding these algorithms to be used, and a public key which is used by the peer entity to validate the authenticity of the certificate.

Public key infrastructure (PKI) governs the issuance of digital certificates, provides unique digital identities for users, devices and applications, and secures communications between various network entities. PKI migration may be needed, for example, due to a change in the CA of the PKI, or an expiry/revocation of CA's root certificate(s).

During a procedure of PKI migration, especially a procedure of CA migration, applications or services secured by the PKI will be impact. For example, since old digital certificates for these applications or services need to be updated with a new CA root certificate, these applications or services may be interrupted or un-available.

### SUMMARY

This summary is provided to introduce simplified concepts of methods and apparatus for mitigating a risk of service un-availability during a migration of PKI. This summary is not intended to identify key features or essential features of the claimed subject matter, nor is it intended to be used to limit the scope of the claimed subject matter.

According to a first aspect of the disclosure, there is provided a first apparatus. The first apparatus comprises at least one processor, and at least one memory storing instructions that, when executed by the one or more processors, cause the apparatus at least to: cause a creating of a first set of network function instances which is redundant for a second set of network function instances using a new root certificate updated in a migration of certificate authority (CA), wherein respective certificates for the second set of network function instances are to be updated in the migration of CA; and cause services being served by the second set of network function instances to be transferred to the first set of network function instances.

According to a second aspect of the disclosure, there is provided a method. The method comprises: causing a creating of a first set of network function instances which is redundant for a second set of network function instances using a new root certificate updated in a migration of CA, wherein respective certificates for the second set of network function instances are to be updated in the migration of CA; and causing services being served by the second set of network function instances to be transferred to the first set of network function instances.

According to a third aspect of the disclosure, there is provided an apparatus implemented at a network slice management function (NSMF). The first apparatus comprises at least one processor, and at least one memory storing instructions that, when executed by the one or more processors, cause the apparatus at least to: send to a network slice subnet management function (NSSMF), a request for creating a first network slice subnet instance which is redundant for a second network slice subnet instance using a new root certificate updated in a migration of CA, wherein respective certificates for a second set of network function instances deployed in the second network slice subnet instance are to be updated in the migration of CA.

According to a fourth aspect of the disclosure, there is provided a method performed by a NSMF. The method comprises: sending to a NSSMF, a request for creating a first network slice subnet instance which is redundant for a second network slice subnet instance using a new root certificate updated in a migration of CA, wherein respective certificates for a second set of network function instances deployed in the second network slice subnet instance are to be updated in the migration of CA.

According to a fifth aspect of the disclosure, there is provided an apparatus implemented at a network slice subnet management function (NSSMF). The first apparatus comprises at least one processor, and at least one memory storing instructions that, when executed by the one or more processors, cause the apparatus at least to: receive from a NSMF, a request for creating a first network slice subnet instance which is redundant for a second network slice subnet instance, wherein respective certificates for a second set of network function instances deployed in the second network slice subnet instance are to be updated in a migration of CA; in response to the request, create the first network slice subnet instance using a new root certificate updated in the migration of CA; and cause services being served by the second set of network function instances to be transferred to a first set of network function instances deployed in the first network slice subnet instance.

According to a sixth aspect of the disclosure, there is provided a method performed by a NSSMF. The method comprises: receiving from a NSMF, a request for creating a first network slice subnet instance which is redundant for a second network slice subnet instance, wherein respective certificates for a second set of network function instances deployed in the second network slice subnet instance are to be updated in a migration of CA; in response to the request, creating the first network slice subnet instance using a new root certificate updated in the migration of the CA; and causing services being served by the second set of network function instances to be transferred to a first set of network function instances deployed in the first network slice subnet instance.

According to seventh aspect of the disclosure, there is provided a computer readable storage medium, on which instructions are stored, when executed by an apparatus, the instructions cause the apparatus to perform any method according to the second aspect, the fourth aspect and the sixth aspect.

According to fourth aspect of the present disclosure, there is provided computer program product comprising instructions which when executed by an apparatus, cause the apparatus to perform any method according to the second aspect, the fourth aspect and the sixth aspect.

### BRIEF DESCRIPTION OF THE DRAWINGS

Some example embodiments will now be described with reference to the accompanying drawings in which:

FIG. 1 shows a high-level view of an exemplary system secured by PKI;

FIG. 2 is a logic flow chart depicting a method according to an embodiment of the present disclosure;

FIG. 3 illustrates an end-to-end message flow of an exemplary procedure according to embodiments of the present disclosure;

FIG. 4 is a logic flow chart depicting a method according to an embodiment of the present disclosure;

FIG. 5 is a logic flow chart depicting a method according to an embodiment of the present disclosure; and

FIG. 6 shows a simplified block diagram of an apparatus according to an embodiment of the present disclosure.

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout.

Abbreviations that may be found in the specification and/or the drawing figures are defined below, at the end of the detailed description section.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and/or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT), New Radio (NR) and so on. Furthermore, the communications between two communication entities in one or more communication networks may be performed according to any suitable generation communication protocols, including, but not limited to, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As mentioned above, during a procedure of PKI migration, especially a procedure of CA migration, applications or services secured by the PKI (or CA) will be impact. As used herein, “a PKI migration”, “a migration of PKI”, “CA migration”, or “a migration of CA” refers to any change of CA, which causes a change or update of root certificates of a CA in the PKI system. For example, the change of CA may be a change in the root CA providing a root certificate of a root CA, a change in a sub-CA providing a certificate of the sub-CA; an expiry/revocation of the root certificates, or other CA changes in the PKI system.

A root certificate is a public key certificate belonging to a root CA, and is the starting point of a chain of trust in a PKI system. The root certificate is used to issue and verify one or more CA certificates. Then, the CA certificates are used to issue or sign other certificates (such as X.509 certificates), thus forming a credible chain of trust. When a root certificate needs to be updated, all certificates issued or signed (directly or indirectly) by the root certificate also need to be updated accordingly, by using an updated root certificate (also referred to as new root certificate). Then, applications or services secured by these certificates may be interrupted or un-available.

In some PKI system, there are one or more sub-CAs which are signed with the root certificate of the root CA. The sub-CA's certificates are in turn used to issue or sign other certificates for various applications and services. In this scenario, applications or services secured by the sub-CA's certificates may be interrupted or un-available during an update of the sub-CA's certificates. From the perspective of a chain of trust for these applications or services, the sub-CA's certificates may be also taken as a “root certificate”.

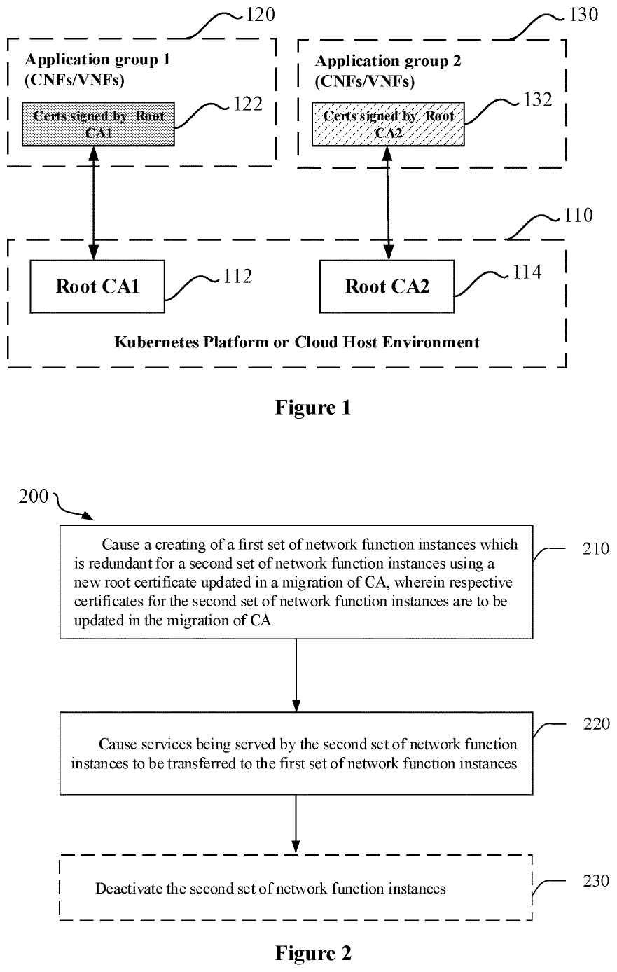

FIG. 1 shows a high-level view of an exemplary system secured by PKI. For example, there may be one or more root CAs deployed in a platform, which hosts one or more network functions (NFs), such as a Kubernetes platform or a cloud computing system (e.g., a cloud host environment). The NFs may be containerized network functions (CNFs), virtualized network functions (VNFs), or the like. As shown in FIG. 1, two root CAs (denoted as Root CA1 and Root CA2, respectively) are deployed in a Kubernetes platform or a cloud host environment 110. Root certificates provided by respective root CAs can be used to issue or sign certificates for various application groups.

An application group may comprise a set of one or more network functions (or NF instances) supported/hosted by the Kubernetes platform or a cloud host environment 110, e.g., for providing a particular type of applications or services. For example, an application group (denoted as 120) may be used to provide video communications, while another application group (denoted as 130) may be used to provide non-real-time communications. In some embodiments, the application groups may be network slices, such as a core network slice of 5GC SBA. In 5GC SBA, digital certificates are used for mutual authentication between NF service producer and consumer. In an example of FIG. 1, digital certificates used for the application group1 120 are issued or signed directly by Root CA1 112, or indirectly by certificates issued or signed by Root CA1 112. The digital certificates used for the application group1 120 are certificates of respective NF instances, and are collectively denoted as 122. Similarly, digital certificates used for the application group2 130 are issued or signed directly by Root CA2 114, or indirectly by certificates issued or signed by Root CA2 114.

In the example of FIG. 1, during a PKI migration procedure, if root certificates of Root CA1 112 need to be updated, applications or services in the application group1 120 will be impacted. For example, certificates issued or signed by Root CA1 112 (directly or indirectly) to NFs of the application group1 120 will need to be signed by using a new root certificate of Root CA1. If root certificates of Root CA2 114 need to be updated, applications or services in the application group2 130 will be impacted. For example, certificates issued or signed by Root CA2 114 (directly or indirectly) to NFs of the application group2 130 will need to be signed by using a new root certificate of Root CA2. If root certificates of both Root CA1 112 and Root CA2 114 need to be updated, all applications or services in the application group1 120 and the application group2 130 will be impacted.

This may lead to un-availability of applications or services provided by respective application groups. For example, in case that the application group is a network slice, this may lead to slice un-availability. During a CA migration procedure, some CNFs can be handling a user plane functionality, some CNFs can be handling various control plane functionalities. If all CNFs and/or VNFs catering to a network slice use a same root CA, there is a risk of un-availability of the full slice. Further, partial un-availability of services may still appear as network un-availability for end users.

To address these and other issues, and as an overview, the present disclosure proposes approaches for mitigating the service un-availability risks during CA migration. An exemplary proposal herein includes: creating new instances of the impacted NFs by using an updated root certificate, and transferring services to the new instances. In this way, services can be seamlessly transferred to new instances without being impacted by CA migrations (changes in root certificates). When services are successfully transferred to the new instances, the old instances of the impacted NFs may be terminated.

FIG. 2 is a logic flow chart depicting a method according to an embodiment of the present disclosure. FIG. 2 illustrates the operation of an exemplary method or methods, a result of execution of computer program instructions embodied on a computer readable memory, functions performed by logic implemented in hardware, and/or interconnected means for performing functions in accordance with exemplary embodiments.

In some embodiments, the blocks in FIG. 2 are assumed to be performed by a functionality entity for managing the network functions deployed in a communication network according to the present disclosure. In an example, the functionality entity may be a network management function, e.g., a network slice management function (NSMF) or a network slice subnet management function (NSSMF), extended with a new capability to provide functions for mitigating a risk of service un-availability during a procedure of CA migration as disclosed in the present disclosure. The functions of this functionality entity may be discretely distributed in NSMF and NSSMF. In another example, the functionality entity may be a separate network security entity which is introduced to be responsible for mitigating a risk of service un-availability during a procedure of CA migration as disclosed in the present disclosure. The functionality entity may rely on a network slice management capability of NSMF, and a network slice subnet management capability of NSSMF.

In block 210, the functionality entity causes a creating of a first set of network function (NF) instances which is redundant for a second set of NF instances using a new root certificate updated in the migration of CA. The NF instances of the second set are old instances of NFs which have been deployed and in use. Respective certificates for the second set of NF instances are to be updated in the CA migration. The CA migration comprises an update of a root certificate used to sign each old NF instances. Thus, these old NF instances would be impacted by the migration of CA. The redundant first set of NF instances may act as a backup of the second set of NF instances. In this regard, for each old NF instance, there is a corresponding redundant NF instance to be created.

In some embodiments, causing the creating of the first set of network function instances may comprise sending a request to another functionality entity, for creating the first set of NF instances. For example, the request may be sent from a network slice selection function (NSMF) to a network slice subnet management function (NSSMF). In other embodiments, causing the creating of the first set of new network function instances may comprises creating the first set of network function instances.

In some embodiments, causing the creating of the first set of new network function instances may comprise: causing each network function instance of the first set of network function instances to be signed by using respective new certificates. The new certificates are that which are generated updated based on the new root certificate. The new certificates may be the new root certificate per se, or other certificates that would be issued or signed by the new root certificate to corresponding NF instances.

In block 220, the functionality entity causes services being served by the second set of NF instances to be transferred to the first set of NF instances. The functionality entity may activate each NF instance of the first set of NF instances newly created. The activated new NF instances are ready to support services transferred the second set of NF instances. The activated new NF instances may also be used to provide other communication services. In some embodiments, the functionality entity may configure the first set of network function instances so that the first set of network function instances is specific for the migration of CA.

The functionality entity may determine whether the migration of CA is about to occur. There may be mechanisms to detect or anticipate the need for CA migration. In an example, the anticipation of the need for CA migration, e.g., a change of root CA, may be come from an input of an operator or a customer. In another example, the CA migration may be trigged by a near-future expiry or revocation of root certificates or sub-CA certificates. Thus, the determination can be made automatedly according to a validity of a root certification or a sub-CA certificate.

In one exemplary embodiment, the functionality entity may receive a notification that the migration of CA is about to occur, for example, from a platform hosting the NFs. Then, the creating of the first set of network function instances may be triggered in response to the notification. In this way, the creating of the set of new network function instances may happen immediately when the migration of CA begins, so that related services can be transferred to the new network function instances in time, thus mitigating service un-availability risks.

Optionally, a network repository function (NRF) may be updated with NF registrations, in order to reflect the new NF instances in the subsequent system level functionalities where new NF instances need to be used. In some embodiments, each new NF instance may be registered to the NRF, e.g., with an indicator indicating each new network function instance has a high priority, and/or each new network function instance is specific for the migration of CA. The registration information (e.g., status or priority) of old NF instances in NRF may also be further updated. For example, a priority of the old NF instances may be lowered down.

After successful completion of the creating of new NF instances, service transferring, and optionally the above procedure of registration of new NF instances and old NF instances, the functionality entity may deactivate the old NF instances, as shown at block 230. In one embodiment, the functionality entity may de-register each NF instance of the second set of NF instances from an NRF. In this regard, the status of the old NF instances may be updated as de-activated. Then, the second set of NF instances may be deleted or locked.

The NF instances to be impacted by the migration of CA may be a group of NF instances, such as the application group1 120 and application group2 130 shown in FIG. 1. In some embodiments, the set of NF instances may be a group of NFs deployed in a network slice subnet instance, such as a CN slice subnet instance. Then, the redundant set of NF instances may be created and processed based on the network slice subnet instance.

In some embodiments as discussed above with reference to FIG. 2, the second set of NF instances is deployed in a second network slice subnet instance, e.g., an old network slice subnet instance which is in use currently. The functionality entity may cause a creating of a first network slice subnet instance redundant for the second network slice subnet instance. The redundant network slice subnet instance newly created may act as a backup of the second network slice subnet instance. In some scenarios, the second set of NF instances may be only a part of NF instances deployed in the second network slice subnet instance. It means that some NF instances deployed in the old network slice subnet instance may not be impacted by the migration of CA. In this case, the NF instances which are not impacted by the migration of CA would be reused for the new network slice subnet instance.

When all the new NFs instances in the first set of NF instances are activated, the first network slice subnet instance may be activated. In an example, after signing all new NF instances with respective new certificates, the new network slice subnet instance with these new NF instances can be activated.

In some embodiments, the functionality entity may further update a network slice selection function (NSSF) with a network slice instance for the first network slice subnet instance. In one exemplary embodiment, once the procedure of CA migration is completed, the old network slice subnet instance can be de-activated or deleted.

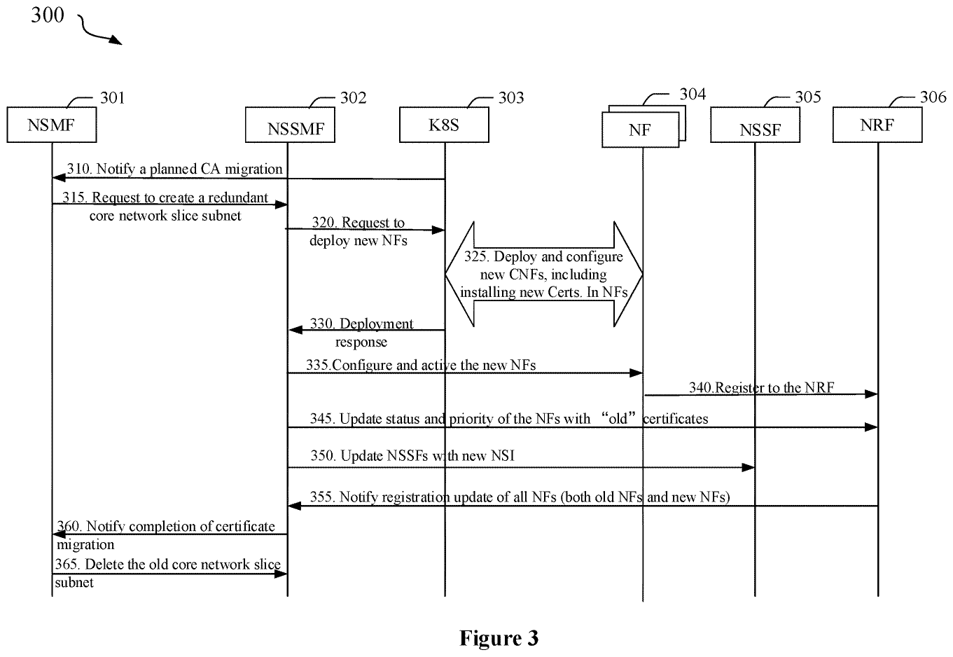

This approach is now described in more detail. Turning to FIG. 3, this figure is an end-to-end message flow of an exemplary procedure according to embodiments of the present disclosure. The message sequence in this figure shows “K8S” 303 for “Kubernetes Platform”. However, this can be any platform or virtualized environment hosting NFs (such as CNFs or VNFs) and a certificate management system. For example, the platform or virtualized environment may be implemented as the platform 110 illustrated in FIG. 1. In this embodiment, it is assumed that root certificates of the root CA or sub-CA are installed in the platform that hosts the CNFs and VNFs.

The platform can have mechanisms to detect or anticipate the need for migrating the PKI. This may be due to near-future expiry or revocation of root certificates of root CA or sub-CA, which are installed in the platform, and used to sign the certificates for CNFs/VNFs hosted in the virtualized environment.

When the platform 303 detects or anticipates the need for such CA migration, it can send a notification to a network slice management function 301 (such as NSMF of 5GC), as shown at 310. For example, the notification may contain information about a planned CA migration, such as an identity of a root CA or sub-CA changed in the CA migration, an identity of a root certificate to be updated in the CA migration, or the like.

When NSMF 301 receives a notification about CA migration from the platform 303, it can request a NSSMF 302 (such as NSSMF of 5GC) to create a new core network slice subnet instance redundant for an old core network slice subnet instance. In an example, NSMF 301 may determine an old core network slice subnet instance which is to be impacted by the planned CA migration, e.g., based on the received identity of the root CA or sub-CA and/or the received identity of the root certificate. As shown at 315, NSMF 301 sends a request to NSSMF 302. In some embodiments, the request may contain information about the old core network slice subnet instance, such as a network slice instance (NSI) identity (ID) identifying the old core network slice subnet instance, a profile or configuration of the old core network slice subnet instance, or other associated parameters. In case that all NFs of the platform use a same CA, the NSMF 301 may request NSSMF 302 to create redundant core network slice subnet instances for all core network slice subnet instances of the platform. In some embodiments, the request in step 315 may contain an indicator indicating that the new network slice subnet instance to be created is specific for the migration of CA.

In response to the request from NSMF 301, NSSMF 302 creates a new core network slice subnet instance. The new core network slice subnet instance may be created based on the information about the old core network slice subnet instance, so as to facilitate a backup of the old core network slice subnet instance. The new core network slice subnet instance is assigned a new NSI, but can be configured with same profile parameters as the old core network slice subnet instance for supporting services to be transferred from the old core network slice subnet instance.

The creating of the new core network slice subnet instance would trigger a creating of NF instances deployed in the new core network slice subnet instance. In an example, NSSMF 302 may request the platform 303 to deploy new instances of CNFs/VNFs for this new network slice subnet instance as shown at 320. In some embodiments, the request may contain information about the old NF instances, such as profile or configurations of the old instances of corresponding CNFs/VNFs, and other associated parameters. Then, as shown at 325, the platform 303 creates and issue new certificates for each of the new instances of CNFs/VNFs, e.g., using a traditional automated certificate management process, and deploys the new instances of CNFs/VNFs in the new core network slice subnet instance. These new certificates are created by using the new root certification. The new certificates could be created before or after NSSMF 302 triggers the platform 303 to deploy new instances of VNF/CNF. This ensures that the new instances of CNFs/VNFs are already migrated to the new CA. After new NF instances with new certificates are deployed, the platform 303 may acknowledges a successful deployment of new NF instances by sending a deployment response to NSSMF 302, as shown at 330.

Upon receiving a successful acknowledgement from the platform, the NSSMF 302 may configure and trigger an activation procedure for the newly created NF instances for the new CN slice subnet instance, as shown at 335. In some embodiments, the NSSMF 302 may configure these new NF instances so that they are specific for the CA migration. Then the new NF instances can be ready to support services in place of corresponding old NF instances.

When a registration process is triggered for the new NF instances, the NFs 304 may register the new NF instances with NRF 306, as shown at 340. In some embodiments, these new NF instances may be configured with a highest priority. Alternatively, an indication can be provided to indicate that these new NF instances is directed to a use-case of CA migration. During this registration process, an indicator indicating a highest priority and/or specifying the use-case of PKI migration may be sent to the NRF 306.

In some embodiments, NSSMF 302 may also update a status and priority of the old NF instances (which are signed or issued with old certificates) to NRF 306, as shown at 345. In this regard, NSSMF 302 may notify NRF 306 of updated status and priority of respective old NF instances. For example, the priority of the old NF instances may be updated as lower priority. In some embodiments, NSSMF 302 may further notify NRF 306 that the update is due to a migration of CA. The status of the old NF instances may be updated as de-activated, e.g., after a completion of the CA migration. The status and priority information could be used by NRF 306 to effectively handle service discovery requests received during a transition period of services from the old NF instances to corresponding new NF instances. In such scenarios, after receiving this update from NSSMF 302, if a discovery request is for a high priority service, NRF 306 can include a “safe” status for new NF instances having new certificates, instead of the old NF instances.

In some embodiments, NSSMF 302 may further update one or more network slice selection functions (NSSFs) 305 (such as 5GC NSSF) with a new NSI for the newly created core network slice subnet slice, as shown at 350. As such, if needed, the new core network slice subnet slice instance (instead of the old core network slice subnet slice instance) would be selected by the NSSF to provide services.

Steps 340, 345 and 350 may enable NRF 306 to complete the registration process. NRF 306 responds (acknowledge) to NSSMF 302 with the updated status of old NF instances and the new NF instances, as shown at 355. At this point, the new NF instances with migrated CA (i.e., with new certificates generated or updated in the CA migration) are active and registered, whereas, the old NF instances could be de-registered and de-activated.

After receiving a successful acknowledgement from NRF 306, NSSMF 302 completes the loop (i.e., complete a creating of a redundant new network slice subnet instance, activating the new network slice subnet instance and corresponding new NF instances, and register the NFs in the new network slice subnet instances to NRF) with NSMF 301, for example, by notifying about a completion of a CA migration process, such as a certificate migration process, as shown at 360.

In some embodiments, in response to receive the notification sent from NSSMF 302 at 360, NSMF 301 365 may notify NSSMF 302 to de-activate the old core network slice subnet instance with old NF instances which are already de-registered, so that the old core network slice subnet instance and the old NF instances is disable to work. In this regard, the old core network slice subnet instance and the old NF instances may be the deleted or locked.

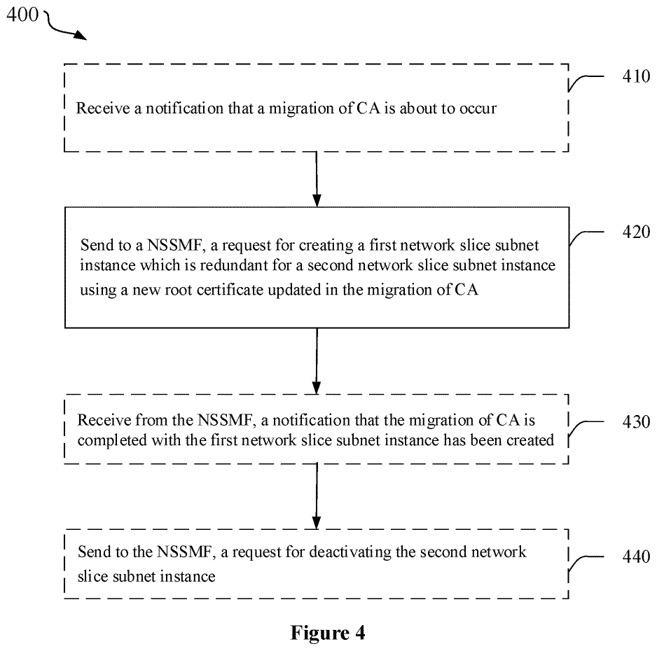

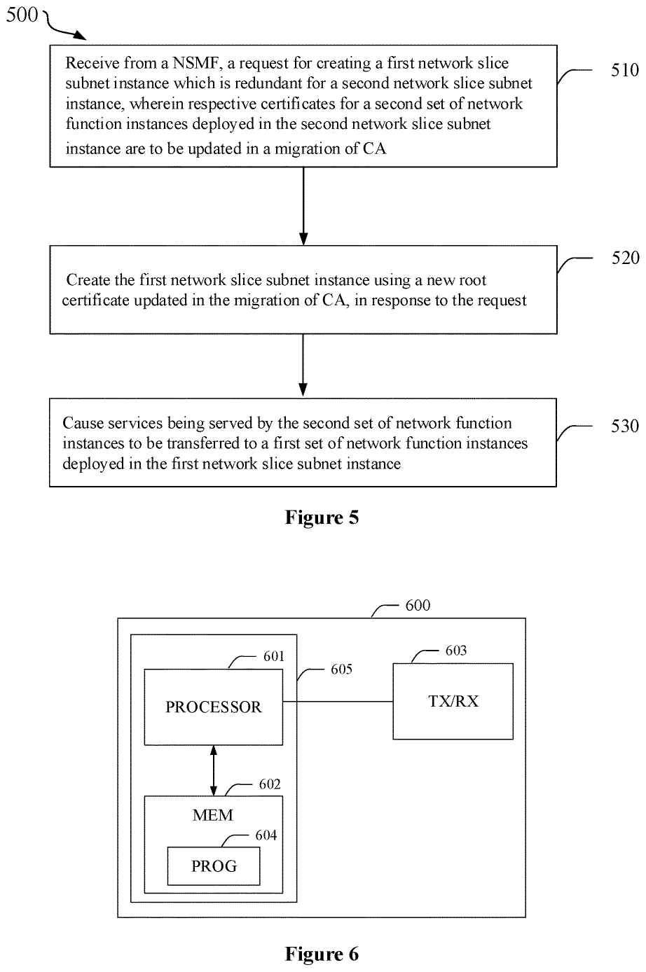

More details of the example embodiments in accordance with the present disclosure will be described with reference to FIG. 4 and FIG. 5. FIG. 4 illustrates a flowchart of a method 400 according to an embodiment of the present disclosure. The method 400 can be implemented at any suitable device. For example, the method 400 can be implemented at a second apparatus, which is configured to implement the NSMF 301 as shown in FIG. 3.

As shown at block 420, a method 400 comprises sending to a network slice subnet management function (such as NSSMF 302), a request for creating a first network slice subnet instance which is redundant for a second network slice subnet instance using a new root certificate updated in a migration of CA. Respective certificates for a second set of network function instances deployed in the second network slice subnet instance are to be updated in the migration of CA.

The request may comprise at least one of the following information: an identity of the second network slice subnet instance; and an indicator indicating that the first network slice subnet instance is specific for the migration of CA.

The request may be triggered by determining that certificates for the second set of network function instances deployed in the second network slice subnet instance are to be updated in a planned migration of CA. In some embodiments, the method 400 may optionally comprises receiving a notification that the migration of CA is about to occur, e.g., from a platform hosting a management system for CA certificates (such as platform 110, 303) as shown at block 410. The request of block 420 may be sent in response to the receiving of the notification.

In some embodiments, the method 400 may further optionally comprise receiving from the NSSMF, a notification that the migration of CA is completed with the first network slice subnet instance has been created, as shown at block 430; and then send to the NSSMF, a request for deactivating the second network slice subnet instance, as shown at block 440.

FIG. 5 is a flowchart of a method 500 according to an embodiment of the present disclosure. The method 500 can be implemented at any suitable device. For example, the method 500 can be implemented at a third apparatus, which is configured to implement the NSSMF 302 as shown in FIG. 3.

As shown at block 510, a method 500 comprises receiving from a network slice management function (such as NSMF 301), a request for creating a first network slice subnet instance which is redundant for a second network slice subnet instance. Respective certificates for a second set of network function instances deployed in the second network slice subnet instance are to be updated in a migration of CA. At block 520, the method 500 comprises creating the first network slice subnet instance using a new root certificate updated in the migration of CA, in response to the request. At block 530, the method 500 comprises causing services being served by the second set of network function instances to be transferred to a first set of network function instances deployed in the first network slice subnet instance.

In some embodiments, the method 500 may further comprise in response to the creating the first network slice subnet instance, triggering a creating of the first set of network function instances which is redundant for the second set of network function instances. Each network function instance of the first set of network function instances is to be signed with respective new certificates which are generated or updated based on the new root certificate. The method 500 may further comprise activating the first set of network function instances; and configuring the first set of network function instances. Each network function instance of the first set of network function instances may be configured to be specific for the migration of CA, so that these new network function instances may be registered to NRF (such as NRF 306) with an indicator that they are different from normal NF instances. In this regard, the method 500 may further comprise causing each network function instance of the first set of network function instances to be registered to a NRF, with an indicator indicating at least one of the following information: each network function instance of the first set of network function instances has a high priority; or each network function instance of the first set of network function instances is specific for the migration of CA.

In some embodiments, the method 500 may further comprise activating the first network slice subnet instance, when the first set of network function instances are activated. Then, the method 500 may further comprise updating a network slice selection function (such as NSSF 305) with a network slice instance for the first network slice subnet instance.

In some embodiments, the method 500 may further comprise updating for each network function instance of the second set of network function instances, a status and priority maintained in a network repository function (such as NRF 306).

In some embodiments, the method 500 may further comprise sending to the NSMF, a notification that the migration of CA is completed with the first network slice subnet instance has been created; and receiving from the NSMF, a request for deactivating the second network slice subnet instance. In response to the request, the method 500 may further comprise deactivating the second network slice subnet instance. The second set of network function instances may be also deactivated. In this regard, the method 500 may further comprise de-registering each network function instance of the second set of network function instances from a NRF; and deleting or locking the second set of network function instances.

Now reference is made to FIG. 6 illustrating a simplified block diagram of an apparatus 600 that may be embodied in/as a network entity (such as NSMF, NSSMF). The apparatus 600 may comprise at least one processor 601, such as a data processor (DP) and at least one memory (MEM) 602 coupled to the at least one processor 601. The apparatus 600 may further comprise one or more transmitters TX, one or more receivers RX 603, or one or more transceivers coupled to the one or more processors 601 to communicate wirelessly and/or through wireline.

Although not shown, the apparatus 600 may have at least one communication interface, for example, the communicate interface can be at least one antenna, or transceiver as shown in the FIG. 6. The communication interface may represent any interface that is necessary for communication with other network entities.

The processors 601 may be of any type suitable to the local technical environment, and may include one or more of the following: general purpose computers, special purpose computers, microprocessors, digital signal processors (DSPs) and processors based on multicore processor architecture, as non-limiting examples.

The MEMs 602 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The MEM 602 stores a program (PROG) 604. The PROG 604 may include instructions that, when executed on the associated processor 601, enable the apparatus 600 to operate in accordance with the embodiments of the present disclosure, for example to perform one of the methods 200, 400, and 500. A combination of the at least one processor 601 and the at least one MEM 602 may form processing circuitry or means 605 adapted to implement various embodiments of the present disclosure.

Various embodiments of the present disclosure may be implemented by computer program executable by one or more of the processors 601, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like. The term “non-transitory” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

The following abbreviations that may be found in the specification and/or the drawing figures are defined as follows:
3GPP 3rd Generation Partnership Project
5G 5th Generation
5GC 5th Generation Core (network)
AN Access Network
CA Certification Authority
CN Core Network
CNF Containerized Network Function
CRL Certificate Revocation List
IPSEC Internet Protocol Security
K8S Kubernetes (Platform)
NF Network Function
NRF Network Repository Function
NSI Network Slice Identity
NSSF Network Slice Selection Function
NSMF Network Slice Management Function
NSSMF Network Slice Subnet Management Function
NW Network
OCSP Online Certificate Status Protocol
RA Registration Authority
SBA Service Based Architecture
S-NSSAI Single-Network Slice Selection Assistance Information
SSH Secure Shell
TLS Transport Layer Security
TN Transport Network
VNF Virtualized Network Function

1-71. (canceled)

72. An apparatus, comprising:
one or more processors; and
one or more memories storing instructions that, when executed by the one or more processors, cause the apparatus at least to:
cause a creating of a first set of network function instances which is redundant for a second set of network function instances using a new root certificate updated in a migration of certificate authority (CA), wherein respective certificates for the second set of network function instances are to be updated in the migration of CA; and
cause services being served by the second set of network function instances to be transferred to the first set of network function instances.

73. The apparatus according to claim 72, wherein when the instructions executed by the one or more processors, further cause the apparatus at least to:
receive a notification that the migration of CA is about to occur, and
wherein causing the creating of the first set of network function instances is performed in response to the receiving of the notification.

74. The apparatus according to claim 72, wherein said causing the creating of the first set of network function instances comprises:
causing each network function instance of the first set of network function instances to be signed with respective new certificates which are generated or updated based on the new root certificate.

75. The apparatus according to claim 72, wherein when the instructions executed by the one or more processors, further cause the apparatus at least to:
activate the first set of network function instances; and
configure the first set of network function instances so that the first set of network function instances is specific for the migration of CA.

76. The apparatus according to claim 72, wherein when the instructions executed by the one or more processors, further cause the apparatus at least to:
cause each network function instance of the first set of network function instances to be registered to a network repository function (NRF), with an indicator indicating at least one of the following information:
each network function instance of the first set of network function instances has a high priority; or
each network function instance of the first set of network function instances is specific for the migration of CA.

77. The apparatus according to claim 72, wherein when the instructions executed by the one or more processors, further cause the apparatus at least to:
update for each network function instance of the second set of network function instances, a status and priority maintained in a network repository function (NRF).

78. The apparatus according to claim 72, wherein when the instructions executed by the one or more processors, further cause the apparatus at least to:
deactivate the second set of network function instances.

79. The apparatus according to claim 78, wherein deactivating the second set of network function instances comprises:
de-registering each network function instance of the second set of network function instances from a network repository function (NRF); and
deleting or locking the second set of network function instances.

80. The apparatus according to claim 72, wherein the second set of network function instances is deployed in a network slice subnet instance.

81. The apparatus according to claim 72, wherein when the instructions executed by the one or more processors, further cause the apparatus at least to:
cause a creating of a first network slice subnet instance which is redundant for a second network slice subnet instance, wherein the second set of network function instances is deployed in the second network slice subnet instance;
wherein the creating of the first set of network function instances is triggered by the creating of the first network slice subnet instance.

82. The apparatus according to claim 81, wherein said causing the creating of the first network slice subnet instance comprises:
sending from a network slice management function (NSMF) to a network slice subnet management function (NSSMF), a request for creating the first network slice subnet instance.

83. The apparatus according to claim 82, wherein the request comprises at least one of:
an identity of the second network slice subnet instance; and
an indicator indicating that the first network slice subnet instance is specific for the migration of CA.

84. The apparatus according to claim 81, wherein when the instructions executed by the one or more processors, further cause the apparatus at least to:
activate the first network slice subnet instance, when the first set of network function instances are activated.

85. The apparatus according to claim 81, wherein when the instructions executed by the one or more processors, further cause the apparatus at least to:
update a network slice selection function (NSSF) with a network slice instance for the first network slice subnet instance.

86. The apparatus according to claim 81, wherein when the instructions executed by the one or more processors, further cause the apparatus at least to:
delete the second network slice subnet instance.

87. The apparatus according to claim 81, wherein the first network slice subnet instance is a core network slice subnet instance.
